(19) United States
(12) Patent Application Publication
(10) Pub. No.: US 2020/0376424 A1
(43) Pub. Date: Dec. 3, 2020

(54) HIGH EFFICIENCY PARTICULATE AIR FILTRATION SYSTEM

(71) Applicant: ProMedica Health System, Inc., Toledo, OH (US)

(72) Inventors: Craig Morse, Toledo, OH (US); Ross Trzcinski, Toledo, OH (US)

(21) Appl. No.: 16/891,246

(22) Filed: Jun. 3, 2020

Related U.S. Application Data
(60) Provisional application No. 62/856,215, filed on Jun. 3, 2019.

(51) Int. Cl. B01D 46/00; B01D 46/52

(52) U.S. Cl. CPC B01D 46/0047; B01D 46/521; B01D 46/0043

(57) ABSTRACT

An air filtration system includes a filtration device having a filter element and a blower, a dispersion casing defining an internal cavity having an inlet fluidly coupled to the blower of the filtration device and an outlet leading to the ambient environment, a duct fluidly coupling the blower of the filtration device to the inlet of the dispersion casing, and a flow reducing feature configured to cause the flow of air to have a reduced flow velocity at the outlet of the dispersion casing in comparison to the inlet of the dispersion casing.

### CROSS-REFERENCE TO RELATED APPLICATION

This patent application claims priority to U.S. Provisional Patent Application Ser. No. 62/856,215, filed on Jun. 3, 2019, the entire disclosure of which is hereby incorporated herein by reference.

### FIELD OF THE INVENTION

The present technology relates to an air filtration system configured to modulate the discharge of filtered air, including a high efficiency particulate air filter system that controls output of a filtered air stream and minimizes disturbance of settled particulates, including irritating or hazardous contaminants, in the ambient environment.

### BACKGROUND OF THE INVENTION

This section provides background information related to the present disclosure which is not necessarily prior art.

It can be desirable to maintain or improve air quality in various environments, including residential, workplace, and healthcare facility environments. In certain areas, levels of certain types of particulates can exceed maximum values, wherein corresponding threshold values can be established either by a defined set of best practices or by a regulatory agency, causing the need for establishing and/or maintaining a clean air environment to become even more apparent. Various particulates of various types and sizes, including pollutants, irritants, allergens, dust, and debris can impact air quality and require a means for removing such particulates to provide a cleaner and healthier environment for both living and working therein. Airborne particulates can also contribute to respiratory infections and illnesses that can be hazardous to individuals with respiratory problems. Particulates of certain types and at certain levels can further result in burning eyes, act as nose and throat irritations, contribute to headaches and dizziness, and can result in coughing and sneezing among other symptoms. Such particulates can also include various types of microorganisms, including mold spores, bacteria, and/or viruses that can increase the risk of infection or illness. Furthermore, many airborne particulates may not only affect individuals residing or working within the corresponding environment, but can affect certain manufacturing processes and the operation of healthcare facilities and the like. Air purification, for example, can be a significant part in establishing and maintaining a specialized environment, such as a clean room or laboratory facility utilized as a part of specialized industrial production (e.g., manufacture of pharmaceuticals, medical devices, and microprocessors), healthcare environments (e.g., operating rooms), and areas dedicated to certain types of scientific research.

In an effort to reduce airborne particulates, many residential and commercial environments utilize a central air filtering system to remove particulates entrained within the air. Unfortunately, such systems can be of limited effectiveness and do not always remove many of the small particulates that can be the most hazardous and irritable, including mold spores, bacteria, viruses, and certain chemicals. Central filtering systems may typically only remove about 300,000 particulates out of about 20 million particulates that flow into a particular filter medium. Small particulates, which can make up a majority of the particulates in the air, can often pass freely through central air filtering systems.

In response, specialized air filters have been developed to remove small particulates. Such filters include those known as high efficiency particulate air (HEPA) filters, also referred to as high efficiency particulate absorber, high-efficiency particulate arresting, or high-efficiency particulate arrestance filters. HEPA filters can have efficiencies defined by government standards, including filters with a minimum efficiency of 99.97% in removing airborne particulates of the size of 0.3 micron (μm) or larger. Such HEPA filters can be used in ultra clean environments, such as clean rooms for integrated circuit fabrication, healthcare facilities, automobiles, aircraft, and residences. A HEPA filter can be defined or classified to satisfy certain thresholds of efficiency, such as those set by the United States Department of Energy (DOE). Varying standards define what qualifies as a HEPA filter, where the two most common standards require the HEPA filter to remove (from the air that passes through) 99.95% (European Standard) or 99.97% (ASME standard) of particulates that have a size greater than or equal to 0.3 micron (μm).

During construction and remediation operations and processes in healthcare facilities, and across other industry platforms, HEPA filtration systems can be used to capture airborne particulates by filtering air through a HEPA filter. Depending on the environment, the maintenance of a clean airspace can provide significant benefits. For example, about 1 out of every 31 hospital patients can experience at least one hospital-associated infection. Infections tied to Aspergillus and certain molds, in particular, have been specifically tied to construction projects and maintenance activities within hospital environments. During such construction and maintenance activities, significant air cleanliness protocols can be put in place, including the use of containment rooms, negative air pressure and air scrubbers, and HEPA filtration systems, all with a goal of decreasing airborne particulates and not exposing patients, staff, and visitors to harmful and potentially infectious particulates.

Filtered air discharged from certain HEPA filtration systems, however, can disturb particulates, including dust, allergens, microorganisms, and other contaminants, that have settled on various surfaces. This often occurs because such HEPA filtration systems tend to include a particularly high volumetric flow rate of the air being exhausted therefrom following the filtration process. The high rate of movement of the filtered air discharge can consequently disturb, take up, and transfer these settled particulates about the environment where the particulates can settle upon new surfaces and/or remain airborne until if or when the air containing such particulates is pulled back through the HEPA filter system once again. As such, the filtered air discharge, formerly scrubbed of undesired particulates, can unfortunately be a force that conveys settled particulates back into the air in contradiction to the intended purpose of such HEPA filtration systems.

Accordingly, there is a need for a HEPA filter system that can minimize impact of a filtered air discharge on disturbing settled particulates.

### SUMMARY OF THE INVENTION

The present technology includes articles of manufacture, systems, and processes that relate to filtering air, including the use of a blower associated with a HEPA filter element and an air dispersion unit to mitigate the disturbance of settled particulates by the discharged filtered air.

According to the present invention an air filtration system includes a blower fluidly coupled to an air dispersion unit. The blower is configured to intake air, move the air through a HEPA filter to provide filtered air, and convey the filtered air to the air dispersion unit. The air dispersion unit is configured to receive the filtered air from the blower into an internal cavity thereof, the internal cavity having one or more means for controlling the movement of the filtered air therein. The air dispersion unit further includes an outlet to discharge the filtered air after the movement of the filtered air is controlled within the air dump unit. The means for controlling the movement of the filtered air can include one or more baffles, dampers, filters, and/or diffusers. The means for controlling the movement of the filtered air can include wherein the internal cavity provides an increase in cross-sectional flow area for the filtered air prior to discharge and exit through the outlet. The outlet of the air dispersion unit can be configured to discharge the filtered air away from surfaces proximate to the air dump unit, such as discharging the filtered air vertically away from potential sources of the particulates within the corresponding environment. Various methods of filtering air using such systems are also provided.

According to one embodiment of the present invention, an air dispersion unit configured to be fluidly coupled to a filtration device having a blower for causing a flow of air to pass through the filtration device and the air dispersion unit is disclosed. The air dispersion unit includes a dispersion casing defining an internal cavity having an inlet fluidly coupled to the blower of the filtration device and an outlet leading to the ambient environment and a flow reducing feature configured to cause the flow of air to have a reduced flow velocity at the outlet of the dispersion casing in comparison to the inlet of the dispersion casing.

According to another embodiment of the present invention, an air filtration system includes a filtration device having a filter element and a blower, a dispersion casing defining an internal cavity having an inlet fluidly coupled to the blower of the filtration device and an outlet leading to the ambient environment, a duct fluidly coupling the blower of the filtration device to the inlet of the dispersion casing, and a flow reducing feature configured to cause the flow of air to have a reduced flow velocity at the outlet of the dispersion casing in comparison to the inlet of the dispersion casing.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of an air filtration system according to an embodiment of the present invention, the air filtration system including a filtration device having a blower for initiating a flow of the filtered air through the filtration device and an air dispersion unit for lowering a flow rate of the filtered air exiting the filtration device;

FIG. 2 is a fragmentary cross-sectional elevational view of the air dispersion unit of the filtration system as taken from the perspective of section lines 2-2 in FIG. 1;

FIG. 3 is a schematic view illustrating a filtration system having a plurality of the filtration devices fluidly coupled to a single air dispersion unit with each of the filtration devices associated with an independently provided inlet into the air dispersion unit;

FIG. 4 is a schematic view illustrating a filtration system having a plurality of the filtration devices fluidly joined to a single manifold conduit leading to a corresponding inlet of the air dispersion unit; and

FIG. 5 is a fragmentary cross-sectional elevational view of an air dispersion unit according to another embodiment of the present invention having a different flow configuration therethrough in comparison to the air dispersion unit of FIGS. 1 and 2.

### DETAILED DESCRIPTION OF THE INVENTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9,1-8,1-3,1-2,2-10,2-8,2-3,3-10,3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology provides air filtration systems and methods that are operable to control a filtered air stream output to minimize disturbance of particulates, including irritating or hazardous contaminants, that reside on various surfaces within an environment, thereby serving to improve and/or maintain a standard of filtered air within the ambient environment. The disclosed air filtration system 10 includes a blower associated with a filtration device 12 and an air dispersion unit 20 disposed downstream of the blower with respect to a direction of flow of the air through the air filtration system 10, wherein the air dispersion unit 20 is configured to reduce the flow velocity of the filtered air when exhausted to the ambient environment from the air filtration system 10.

The blower is configured to intake air, move the air through a filter element (not shown) of the filtration device 12 in order to filter the air in accordance with the requirements of the given application, and to subsequently convey the filtered air to the air dispersion unit 20. In the presently disclosed embodiment, the blower is incorporated into the structure of the filtration device 12 and is therefore not individually illustrated or identified herein. The blower may be any type of fan, pump, compressor, or the like suitable for generating the necessary pressure for causing the flow of the air to pass through the filter element of the filtration device 12 at a desired volumetric flow rate. If incorporated into the structure of the filtration device 12, the blower may be disposed upstream or downstream of the corresponding filter element within a housing of the filtration device 12 defining a flow path through the filtration device 12, as desired. In other embodiments, the blower may be provided independently of the filtration device 12 while fluidly coupled to the filtration device 12 at an upstream or downstream position by any suitable duct or conduit, so long as the blower maintains the ability to push or draw the air through the filter element of the filtration device 12.

Each of the filtration devices 12 shown and described herein may include a HEPA filter element having a predetermined filtration rating for the desired application. However, it should be understood by one skilled in the art that the disclosed air filtration system 10 may be associated with any type of filter element having any filtration rating, as desired, while remaining within the scope of the present invention.

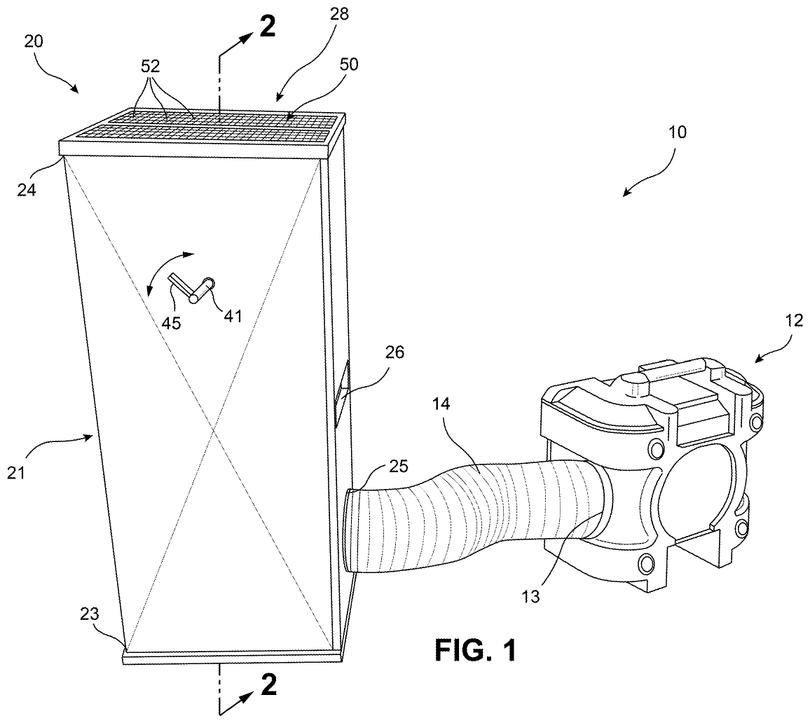

The filtration device 12 may be fluidly coupled to the air dispersion unit 20 via a corresponding duct 14. In the illustrated embodiment, the duct 14 is provided as a flexible and expandable conduit having the ability to accommodate varying positions and orientations of the filtration device 12 relative to the air dispersion unit 20, thereby expanding the possible configurations of the air filtration system 10 relative to the corresponding environment. Specifically, the duct 14 is illustrated in FIG. 1 as including a first end coupled to an exhaust port 13 of the filtration device 12 and an opposing second end coupled to an inlet 25 of the air dispersion unit 20. The exhaust port 13 is provided on the filtration device 12 at a position downstream of the associated blower thereof and may normally form the outlet of the filtration device 12 when not coupled to the remainder of the air filtration system 10 as disclosed herein. The exhaust port 13, the duct 14, and the inlet 25 are each illustrated as including a circular cross-sectional shape defining a circular flow area through each of the components 13, 14, 25. However, the listed components 13, 14, 25 may each include any associated cross-sectional shape and flow area configuration, as desired, so long as the components 13, 14, 25 are adapted to form a desired sealing effect between the filtration device 12 and the air dispersion unit 20. Any suitable connectors, fittings, adapters, or the like may be provided as each end of the duct 14 for connecting each of the ends of the duct 14 to the filtration device 12 and the air dispersion unit 20, as desired.

The air dispersion unit 20 includes a dispersion casing 21 defining a hollow internal cavity 22. The dispersion casing 21 may be formed from any substantially rigid material such as various plastics or metals, as desired. In some embodiments, the dispersion casing 21 may be provided as a galvanized metal box, as desired. The dispersion casing 21 and the corresponding internal cavity 22 may each include a substantially rectangular cuboid shape with a corresponding square or rectangular cross-sectional shape and hence flow area that is extended along a longitudinal direction of the dispersion casing 21 from a first end 23 to a second end 24 thereof. The dispersion casing 21 may alternatively be referred to as a dispersion box based on the disclosed rectangular cuboid shape thereof. The first end 23 of the dispersion casing 21 may be closed to form a base of the dispersion casing 21 configured for resting on a ground surface or other horizontally disposed resting surface to establish a vertical arrangement of the longitudinal direction of the dispersion casing 21 with the second end 24 thereof spaced apart from the ground/resting surface. The square or rectangular cross-sectional shape of the dispersion casing 21 may be formed by four upstanding sidewalls extending longitudinally between the base and a diffuser plate 50 forming a cap of the dispersion casing 21 at the second end 24 thereof.

The aforementioned inlet 25 may be provided through one of the sidewalls at a position adjacent the first end 23 of the dispersion casing 21 as formed by the base thereof. The inlet 25 forms an opening into the interior cavity 22 of the dispersion casing 21 for the air conveyed through the duct 14 from the filtration device 12. The aforementioned diffuser plate 50 forms an outlet 28 of the dispersion casing 21 through which the air is exhausted to the ambient environment after flowing primarily in the longitudinal (vertical) direction of the dispersion casing 21. The incorporation of the inlet 25 into one of the sidewalls of the dispersion casing 21 leads to the air generally undergoing a 90 degree turn when transitioning from flowing out of the duct 14 and into the internal cavity 22 of the dispersion casing 21. The provided 90 degree turn in the flow direction of the air aids in lowering the pressure of the air when entering the dispersion casing 21, which in turn reduces the flow velocity of the air as it progresses towards the outlet 28 of the dispersion casing 21.

The flow area through the dispersion casing 21 is selected to be greater than the flow area through the inlet 25 to allow for the air entering the dispersion casing 21 to disperse in a manner lowering the pressure of the air, which in turn lowers the flow velocity of the air as the air progresses from the inlet 25 to the outlet 28. The square or rectangular flow area through the dispersion casing 21 is arranged perpendicular to the longitudinal direction thereof, wherein the longitudinal direction coincides with the general direction of flow of the air when progressing from the inlet 25 to the outlet 28 as formed by the diffuser plate 50. In the provided embodiment, the dispersion casing 21 may be provided as a 20″×20″×48″ box while the inlet 25 may be provided as a cylinder including an 8″ diameter. Using these dimensions, the air expands to include about an 8 times greater flow area when traveling through the internal cavity 22 in the longitudinal direction of the dispersion casing 21 in comparison to the flow out of the duct 14 and the corresponding inlet 25. However, it should be appreciated by one skilled in the art that any combination of dimensions and cross-sectional shapes resulting in an expansion and corresponding dispersion of the air when entering the internal cavity 22 through the inlet 25 may be utilized while still appreciating the benefits of the present invention, so long as the cross-sectional flow area through the dispersion casing 21 is greater than the flow area through the duct 14 and the inlet 25.

A filter element 30 is provided across the flow area of the internal cavity 22 at an orientation perpendicular to the longitudinal direction of the dispersion casing 21. The filter element 30 is illustrated as having a corrugated or pleated configuration, but alternative filter types or configurations may be utilized without necessarily departing from the scope of the present invention. The dispersion casing 21 is provided to include an opening 26 in one of the sidewalls thereof to allow for an ease of insertion and removal of the filter element 30, thereby facilitating a replacement of the filter element 30 when an effectiveness thereof is reduced following a period of use thereof. The opening 26 may lead to a track or tray 27 provided within the structure of the dispersion casing 21 with the track or tray 27 forming a guide for receiving and orienting the filter element 30 when extended across the flow area of the dispersion casing 21. The filter element 30 may be provided as a 20″×20″×1″ pleated filter to accommodate the previously disclosed dimensions of the dispersion casing 21. However, alternative sizes and configurations may be provided to accommodate different configurations of the dispersion casing 21. The filter media may have any desired porosity in accordance with the desired pressure drop across the filter element 30, and may accordingly be formed from any suitable filter material such as polyester, fiberglass, or cotton, as non-limiting examples.

In addition to filtering any particulates not captured by the filtration device 12, the filter elements 30 further aids in reducing the pressure and henceforth the flow velocity of the air passing through the dispersion casing 21. More specifically, the energy required for the air to pass through the tortuous flow paths formed by the porous structure of the filter element 30 beneficially leads to the reduction in the pressure of the air.

A baffle 40 is also provided within the internal cavity 22 of the dispersion casing 21 and acts as a flow damper with respect to the flow of the air through the air dispersion unit 20. In the illustrated embodiment, the baffle 40 is provided at a position downstream of the filter element 30, but the positions of the filter element 30 and the baffle 40 may be switched without necessarily departing from the scope of the present invention. The illustrated baffle 40 is a manually adjustable baffle formed by a baffle plate 42 coupled to a shaft 41 defining an axis of rotation of the baffle plate 42. The shaft 41 may extend between opposing side surfaces of the dispersion casing 21 in a manner allowing for selective rotation of the shaft 41 relative to the dispersion casing 21. As can be seen in FIG. 1, the shaft 41 may extend outside of the internal cavity 22 through one of the sidewalls of the dispersion casing 21 to allow for the manual adjustment of the rotational position of the baffle plate 42. For example, an outwardly disposed end of the shaft 41 may include a handle 45 projecting outwardly from the shaft 41 at an orientation perpendicular to the shaft 41, wherein the handle 45 can be grasped by an operator of the air filtration system 10 in order to selectively rotate the shaft 41. The baffle plate 42 is illustrated as being coupled to the shaft 41 at a central position thereof, but alternative configurations of the baffle plate 42 relative to the shaft 41 may be utilized while remaining within the scope of the present invention, including configurations wherein the shaft 41 is coupled to the baffle plate 42 adjacent an end thereof to cause the entirety of the baffle plate 42 to pivot around the shaft 41.

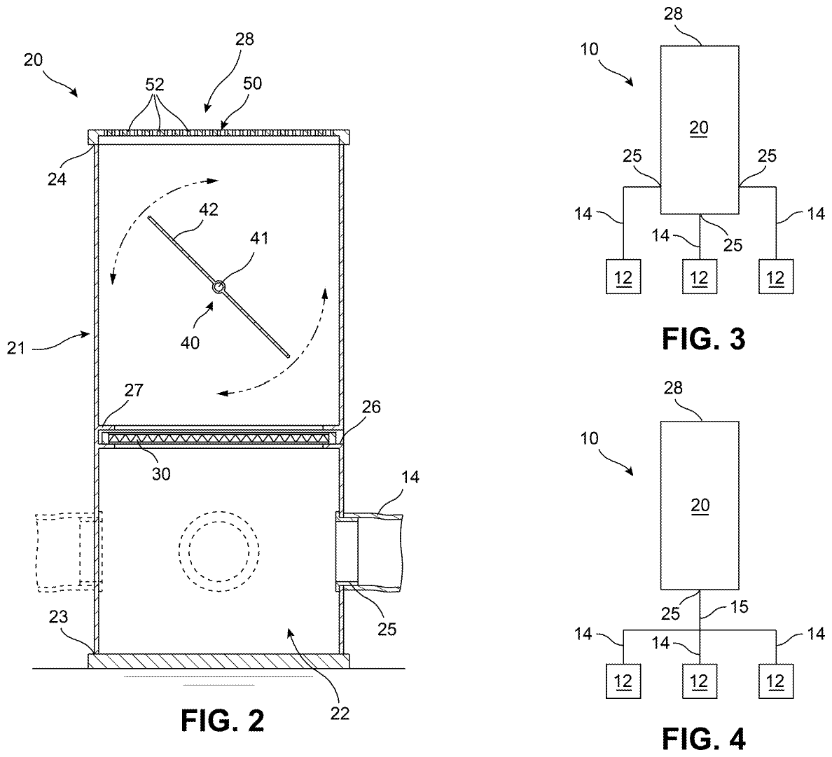

As is apparent from a review of FIG. 2, the rotational position of the baffle plate 42 within the internal cavity 22 leads to a variable flow restriction through the internal cavity 22 before allowing for the air to recombine to the same flow area downstream of the baffle plate 42. The baffle plate 42 may be adjusted to a first position wherein the baffle plate 42 is arranged substantially perpendicular to the flow direction of the air through the internal cavity 22 for maximizing the flow restriction, a second position wherein the baffle plate 42 is arranged substantially parallel to the flow direction of the air through the internal cavity 22 for minimizing the flow restriction, and any number of intermediate positions between the first position and the second position. FIG. 2 illustrates the baffle plate 42 at an exemplary intermediate position having about a 45 degree angle relative to the flow direction of the air through the internal cavity 22.

The manner in which the baffle plate 42 extends across the flow area causes the flow of the air to change direction when encountering the baffle plate 42 while also forming friction between the air and the baffle plate 42. Furthermore, the reduction in flow area adjacent the baffle plate 42 leads to energy being expended when the air is accelerated past the baffle plate 42 before being recombined to the same flow area downstream of the baffle plate 42. Each of these conditions lead to the baffle 40 further reducing the pressure of the air after having passed by the baffle 40 and recombined within the internal cavity 22, which again lowers the flow velocity of the air when progressing towards the outlet 28 of the dispersion casing 21.

The baffle 40 is shown and described as being adjustable, but it should be understood that the baffle 40 may also be provided as one or more permanently installed elements oriented to block the flow of the air in a manner causing the reduction of the pressure of the air passing through the dispersion casing 21 while remaining within the scope of the present invention. Furthermore, the single rotatable baffle plate 42 may be replaced with multiple rotatable baffle plates arranged in any desired configuration, such as placed in series or placed side-by-side across the flow area of the dispersion casing 21, as desired. For example, a plurality of the baffle plates may be arranged in a configuration resembling a slatted vent or the like, as desired, wherein a single manual adjustment of a corresponding handle or the like causes each of the baffle plates to rotate in unison.

The diffuser plate 50 includes a perforated surface including a plurality of openings or perforations 52 through which the air passes when exiting the dispersion casing 21. The openings or perforations 52 may be provided to include any desired pattern or configuration, as desired, and may be provided as a screen element or the like. The diffuser plate 50 may be provided to be removable from the remainder of the dispersion casing 21 to provide for access to the interior of the dispersion casing 21, as desired. In similar fashion to the filter element 30 and the baffle 40, the diffuser plate 50 forms a flow restriction through the air dispersion unit 20 that reduces the pressure of the air when flowing through the outlet 28 formed by the openings or perforations 52 of the diffuser plate 50, which once again aids in lowering the flow velocity of air when expelled from the air dispersion unit 20. The grid-like pattern of the openings 52 further forms a safety feature wherein the interior components of the air dispersion unit 20 cannot be reached while the air filtration system 10 is in operation.

As described hereinabove, the enlarged flow area of the dispersion casing 21 and the flow resistance provided by each of the filter element 30, the baffle 40, and the diffuser plate 50 all aid in reducing the pressure of the air passing through the air dispersion unit 20 as the air proceeds from the inlet 25 to the outlet 28 formed by the diffuser plate 50. The continuous reduction in the pressure of the air through the air dispersion unit 20 in turn ensures that the air flows out of the air filtration system 10 with a significantly reduced flow velocity, thereby reducing the occurrence of the air exhausted from the filtration device 12 disturbing any particulates adjacent the air filtration system 10 via the dynamic pressure effects typical of a high velocity stream of air. The presence of the enlarged flow area through the dispersion casing 21 in comparison to the inlet 25, the filter element 30, the baffle 40, and the diffuser plate 50 may accordingly each be referred to as flow reducing features with respect to the flow of the air passing through the air filtration system 10.

It should be understood by one skilled in the art that any combination and order of the disclosed flow reducing features may be employed within the air dispersion unit 20 while remaining within the scope of the present invention, so long as the velocity of the air is reduced when exiting the air filtration system 10 to the desired degree for the given application, hence the air dispersion unit 20 is not limited to the configuration illustrated in FIGS. 1 and 2. Additionally, as mentioned above, in some circumstances multiple of any one of the disclosed flow reducing features may also be employed within the air dispersion unit 20 in any desired configuration while also remaining within the scope of the present invention.

The box-like shape of the dispersion casing 21 may be provided to render it easier to remove or replace components such as the filter element 30, the baffle 40, and the diffuser plate 50 due to the square shapes thereof and the availability of such components (particularly the filter element 30), but it should be understood that the air dispersion unit 20 may be provided with any suitable cross-sectional flow shape with each of the listed components 30, 40, 50 similarly adapted to the corresponding cross-sectional flow shape while remaining within the scope of the present invention.

The vertical air release provided by the orientation of the disclosed air dispersion casing 21 further results in less disruption to the native air space adjacent the air filtration system 10, thereby decreasing the amount of contaminants that are dislodged from various settled positions to become airborne. For example, the outlet 28 of the air dispersion unit 20 is directed upwardly away from the horizontal ground/resting surface on which the air dispersion unit 20 is disposed, wherein such a horizontal ground/resting surface may present the most likely position within the given environment for such particulates to have previously settled. Additionally, the outlet 28 of the air dispersion unit 20 may also be configured to be adjustable between various positions to optimize the discharge direction of the filtered air with respect to surfaces in the given environment. As mentioned previously, the use of a flexible or expandable duct 14 for connecting the filtration device 12 to the air dispersion unit 20 may also be advantageous for selectively inletting and exhausting the filtered air at desired positions and orientations relative to the air filtration system 10 for maximizing the filtering effects and minimizing the particulate disturbance generated by the air filtration system 10.

Various embodiments of the air filtration system 10 can be configured in a modular manner, where for example, multiple filtration devices 12 can provide filtered air to one or more air dispersion units 20. For example, FIG. 2 illustrates two potential additional inlets (shown in broken lines) intersecting the sidewalls of the air dispersion casing 21 to allow for additional filtration devices 12, each associated with an independently provided blower and air duct 14, to be placed in fluid communication with a single air dispersion unit 20. When not in use, such additional inlets may be covered with a cap element or the like to prevent the undesired outflow of the air entering the air dispersion unit 20 from any of the other inlets fluidly coupled to one of the filtration device 12 via corresponding ducts 14. Although three inlets are illustrated, any number of the inlets may be provided so long as the air dispersion casing 21 maintains a larger flow area than the combined flow area through each of the inlets being utilized. FIG. 3 schematically illustrates such a configuration wherein three of the filtration devices 12 powered by independently provided blowers all lead into the air dispersion unit 20 via independently provided ducts 14. In contrast, FIG. 4 schematically illustrates a configuration wherein each of the independently provided filtration device 12 (each having its own blower) is fluidly coupled to a single manifold duct 15 that is turn fluidly coupled to a single inlet 25 of the air dispersion unit 20, wherein the manifold duct 15 is formed by the flow of each of the corresponding ducts 14 combining upstream of the inlet 25 of the air dispersion unit 20. One skilled in the art should appreciate that additional combinations of the disclosed configurations may similarly be utilized for reducing the pressure and resulting flow velocity of the air when exiting the air dispersion unit 20, as desired. Such configurations associated with multiple different filtration devices 12 and the corresponding blowers allows for the air filtration system 10 to be tailored for filtering different volumes of air, filtration rates, and/or different environments.

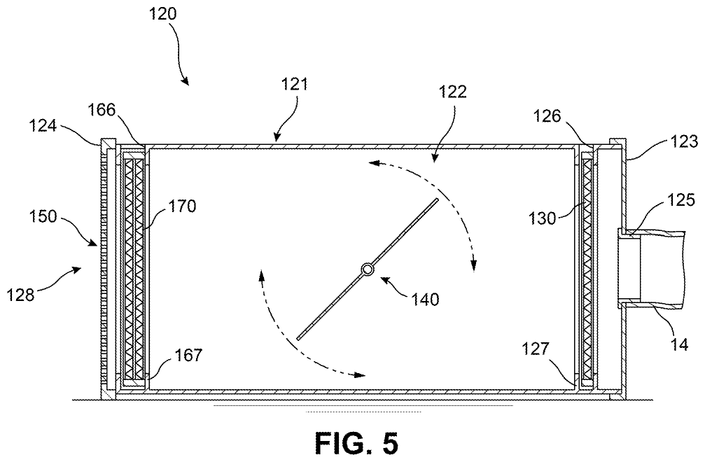

Referring now to FIG. 5, an air dispersion unit 120 according to another embodiment of the invention is disclosed. The air dispersion unit 120 is substantially similar in many respects to the air dispersion unit 20 illustrated in FIGS. 1 and 2, hence the primary differences between the air dispersion units 20, 120 are focused on hereinafter. The air dispersion unit 120 includes a horizontal orientation suitable for exhausting air therefrom in a horizontal direction rather than the aforementioned vertical direction disclosed with respect to the air dispersion unit 20. The air dispersion unit 120 includes a dispersion casing 121 defining a square or rectangular flow area therethrough within an internal cavity 122 thereof. A first end 123 of the dispersion casing 121 includes an inlet 125 configured for coupling to a duct 14 associated with one or more filtration devices 12. Although not pictured, the first end 123 of the dispersion casing 121 may include additional inlets for fluidly coupling the dispersion casing 121 to multiple filtration devices 12 each having its own blower, as desired. A second end 124 of the dispersion casing 121 includes a removable diffuser plate 150 forming an outlet 128 of the dispersion casing 121. A general direction of flow through the dispersion casing 121 is accordingly arranged parallel to the longitudinal direction of the dispersion casing 121 from the inlet 125 to the outlet 128 as formed by the diffuser plate 150.

The dispersion casing 121 includes each of a first filter element 130, a baffle 140, a second filter element 170, and the diffuser plate 150 in that order with respect to the direction of flow of the air through the dispersion casing 121. The first filter element 130 is associated with a corresponding opening 126 and track or tray 127 while the second filter element 170 is similarly associated with a corresponding opening 166 and track or tray 167, each of which serve the same functions as the opening 26, track or tray 27, and filter element 30 of the air dispersion unit 20. The second filter element 170 is shown as being a double-layered pleated filter element, but any configuration or combination of the filter elements 130, 70 may be utilized without necessarily departing from the scope of the present invention. The baffle 140 and the diffuser plate 150 operate in similar fashion to the baffle 40 and the diffuser plate 50, hence further description of each element is omitted hereinafter.

The air dispersion unit 120 may be configured for use with any number of filtration devices 12 as described hereinabove and shown schematically in FIGS. 3 and 4. Furthermore, the order, presence, and number of any of the pressure or velocity reducing features associated with the air dispersion unit 120 may also be modified so long as the desired effect is achieved for reducing the disturbance of particulates adjacent the air dispersion unit 120.

The present air filtration systems and ways of using such systems can thereby reduce disturbance of settled particulates in order to prevent the introduction of new particulates into the just filtered air discharge. Tempering the discharge of filtered air, by controlling discharge direction, reducing the flow rate, and/or by diffusing the filtered air, can improve the efficiency of the air filtration system with respect to operation time to achieve an air quality standard, improve the longevity of the HEPA filter, and provide a reduction in the transport of settled particulates outside of the immediate environment.

The present technology can be especially useful during construction and remediation processes in healthcare facilities and across other industry platforms. The present systems and methods can be used to exhaust filtered/clean air out of a construction space and into the interior of a facility without disturbing particulates settled on various surfaces, such as floors, work surfaces, production lines, desks, tables, and other fixtures within an environment. This is in contrast to other systems that discharge filtered air at a direction, rate, and/or force that can disturb settled particulates and cause them to become airborne, thereby contravening the purpose and function of the formerly clean and filtered air stream. As such, the present technology can be particularly useful within healthcare and other facilities as the undesired disturbance and dispersal of settled particulates can result in secondary infections for patients.

Various benefits and advantages are realized by the present technology. Currently, exhausted air comes out of a HEPA filtration device at a high volumetric flow rate leading to high exhaust velocity—generally horizontally and near the ground/resting surface. This disrupts settled dust, dirt, and other potential airborne contaminants. Patients, staff, and visitors can then be at risk to breathe these contaminants in, increasing their risk for infection. By running the cleaned exhausted air through the negative filtration systems provided herein, the system can further filter the air in the air dispersion unit one additional time, can decrease the exhaust flow rate, and can control the discharge direction (e.g., provide a vertical discharge). The end result is filtered air that is coming out more slowly and causing significantly less disruption to settled contaminants. The present technology can benefit healthcare facilities, long term care, physician's offices, schools, government buildings, etc. It can further be employed by construction/project managers, facility managers, and building managers.

The present technology operates in a way such that undisturbed settled particulates on various surfaces within an environment can therefore be collected by washing, dusting, vacuuming, or other surface cleaning methods. Transport of particulates throughout an environment and between different environments by air movement is accordingly minimized or avoided, undesired respiratory contact is prevented, HEPA filter life is improved, and the time needed to achieve an ambient atmosphere at or below a certain particulate level is reduced.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An air dispersion unit configured to be fluidly coupled to a filtration device having a blower for causing a flow of air to pass through the filtration device and the air dispersion unit, the air dispersion unit comprising:
a dispersion casing defining an internal cavity having an inlet fluidly coupled to the blower of the filtration device and an outlet leading to the ambient environment; and
a flow reducing feature configured to cause the flow of air to have a reduced flow velocity at the outlet of the dispersion casing in comparison to the inlet of the dispersion casing.

2. The air dispersion unit of claim 1, wherein the flow reducing feature is a greater cross-sectional flow area present through the internal cavity of the dispersion casing than through the inlet.

3. The air dispersion unit of claim 1, wherein the flow reducing feature is a filter element extending across a cross-sectional flow area through the internal cavity.

4. The air dispersion unit of claim 3, wherein the filter element is received through an opening formed in the dispersion casing to facilitate replacement of the filter element.

5. The air dispersion unit of claim 1, wherein the flow reducing feature is a baffle disposed within the internal cavity.

6. The air dispersion unit of claim 5, wherein the baffle is adjustable to vary a cross-sectional flow area through the internal cavity at the baffle.

7. The air dispersion unit of claim 6, wherein the baffle includes a baffle plate coupled to a rotatable shaft, wherein the shaft extends outside of the dispersion casing to allow for manual adjustment of an angle of baffle plate relative a flow direction of the flow of air through the internal cavity.

8. The air dispersion unit of claim 1, wherein the flow reducing feature is a diffuser.

9. The air dispersion unit of claim 8, wherein the diffuser forms the outlet of the dispersion casing.

10. The air dispersion unit of claim 8, wherein the diffuser is provided as a plate having a plurality of perforations formed therethrough.

11. The air dispersion unit of claim 1, wherein the inlet is fluidly coupled to the blower of the filtration device by a flexible duct.

12. The air dispersion unit of claim 1, wherein the dispersion casing includes a plurality of the inlets with each of the inlets disposed downstream of a corresponding filtration device.

13. The air dispersion unit of claim 1, wherein the inlet of the dispersion casing is fluidly coupled to a plurality of the filtration devices.

14. The air dispersion unit of claim 1, wherein the filtration device includes a HEPA filter element.

15. The air dispersion unit of claim 1, wherein the flow reducing feature includes at least two members of a group consisting of: a baffle, a filter element, a diffuser, and a greater cross-sectional flow area present through the internal cavity of the dispersion casing than through the inlet.

16. An air filtration system comprising:
a filtration device having a filter element and a blower;
a dispersion casing defining an internal cavity having an inlet fluidly coupled to the blower of the filtration device and an outlet leading to the ambient environment; and
a flow reducing feature configured to cause the flow of air to have a reduced flow velocity at the outlet of the dispersion casing in comparison to the inlet of the dispersion casing.

17. The air filtration system of claim 16, wherein the flow reducing feature includes a member of a group consisting of: a baffle, a filter element, a diffuser, a greater cross-sectional flow area present through the internal cavity of the dispersion casing than through the inlet, and combinations thereof.

18. The air filtration system of claim 16, wherein the filter element of the filtration device is a HEPA filter element.

19. The air filtration system of claim 16, further including a flexible duct fluidly coupling the blower of the filtration device to the inlet of the dispersion casing.

20. The air filtration system of claim 16, wherein the dispersion casing is fluidly coupled to a plurality of the filtration devices.
